(19) United States
(12) Patent Application Publication
(10) Pub. No.: US 2018/0013223 A1
(43) Pub. Date: Jan. 11, 2018

(54) ELECTRICAL CONNECTOR

(71) Applicant: SMK Corporation, Tokyo (JP)

(72) Inventors: Koichiro EJIRI, Kanagawa (JP); Haruhiko KONDO, Kanagawa (JP)

(21) Appl. No.: 15/592,202

(22) Filed: May 11, 2017

(30) Foreign Application Priority Data
Jul. 5, 2016 (JP) 2016-132993

(51) Int. Cl. H01R 13/405; H01R 13/05

(52) U.S. Cl. CPC H01R 13/405; H01R 13/05; H01R 2201/16

(57) ABSTRACT

An electrical contact that facilitates reduction in size is provided. An electrical connector for charging a mobile device is configured such that a metallic contact and a resin housing being part of a chassis are integrally molded including a bonding layer formed on the surface of wall portions of the contact. This configuration can enhance the bonding strength by the bonding layer, thereby enabling the electrical connector to be reduced in size.

### CROSS REFERENCE TO RELATED APPLICATION

The contents of the following Japanese patent application are incorporated herein by reference,

Japanese Patent Application No. 2016-132993 filed on Jul. 5, 2016.

### FIELD

The present invention relates to an electrical connector.

### BACKGROUND

Electrical connectors have been used as means for electrically connecting, for example, mobile terminals such as mobile phones or smartphones, and are fit for a wide range of uses such as for charging purposes, card type memory devices, and interfaces.

For example, as an electrical connector for charging purposes, disclosed in Patent Literature 1 is a structure in which contacts and a holder are integrally molded so as to incorporate the holder into a chassis.

For example, as an electrical connector for card type memory devices, disclosed in Patent Literature 2 is a structure in which contacts and a housing are integrally molded so as to secure the contacts to the housing.

For example, as an electrical connector for interfaces, disclosed in Patent Literature 3 is a structure in which contacts and a housing are integrally molded so as to allow the contact surface of the contacts to be protruded from the housing surface.

### CITATION LIST

### Patent Literature

Patent Literature 1: Japanese Patent Application Laid-Open No. 2008-288151

Patent Literature 2: Japanese Patent Application Laid-Open No. 2004-192928

Patent Literature 3: Japanese Patent Application Laid-Open No. 2013-114988

### SUMMARY

### Technical Problem

Electrical connectors have been required to be reduced in size. To reduce the electrical connector in size, there is no other choice but to reduce the range of the metallic contacts held by the housing made of a resin. Thus, the smaller the range of the contacts being held, the lower the holding strength became.

In the structure shown in Patent Literature 1, metallic contacts 70 and a resin holder 71 are integrally molded so as to incorporate the holder 71 into a chassis 72. The holder 71 is provided with a projection 73 so as to be secured to the chassis 72. With decreases in the size of the mobile terminal, the projection 73 is required to be reduced in thickness. However, the thinner the projection made of a resin, the lower the strength against the load of mating contacts became upon mating of the mating connector.

In the structure shown in Patent Literature 2, metallic contacts 80 and a housing 81 are integrally molded so as to secure the contacts 80 to the housing 81. To secure the contacts 80 in the housing 81, the entire perimeter of the secured portion of the contacts 80 is covered with the housing 81. That is, there is a resin for forming the housing 81 on both sides of the contacts 80 in the thickness direction of the electrical connector, whereby the requirement for reduction in the thickness could not be satisfied.

In the structure shown in Patent Literature 3, metallic contacts 90 are integrally molded with and secured in a housing 91 while the contact surface 92 of the contacts 90 is protruded from a hold surface 93. When the contacts 90 and the housing 91 had not been brought into intimate contact with each other, moisture might enter into the boundary between a side surface 94 perpendicular to the contact surface 92 of the contact 90 and the housing 91, thus causing corrosion to occur and advance on the moisture laden part at the time of energization.

The present invention has been made in view of these problems, and it is an object of the present invention to facilitate reduction in size of an electrical connector with contacts and a housing integrally molded.

It is also another object of the present invention to provide an electrical connector having such a structure that prevents moisture from entering with ease into the boundary between the contacts and the housing, has a high resistance to corrosion, and allows the contacts and the housing to be integrally molded.

### Solution to Problem

To solve the aforementioned problems, an electrical connector of a first aspect of the present invention includes a metallic contact, and a housing molded integrally with the contact and made of an insulating resin. In the electrical connector, the contact has, on at least part thereof in contact with the housing, a bonding layer bonded to the housing, and the contact and the housing are bonded together with the bonding layer therebetween.

In the electrical connector of a second aspect of the present invention, the bonding layer may be a layer configured to chemically bond the contact and the housing together.

In the electrical connector of a third aspect of the present invention, the contact may include an air gap on a surface thereof, and the bonding layer may be a layer formed by the insulating resin of the housing entering into the air gap so as to bond the contact and the housing together.

In the electrical connector of a fourth aspect of the present invention, the contact may include a contact surface to be brought into contact with a mating connector, and a wall portion provided to extend in a direction in which the wall portion intersects the contact surface, and the bonding layer may be provided to at least part of a surface of the wall portion.

In the electrical connector of a fifth aspect of the present invention, the contact may include an elastically deforming portion that is brought into contact with a mating entity and elastically deformed, an embedded portion to be embedded in the housing, and a connection portion to be connected to a printed circuit board, the embedded portion may include an exposed surface that is formed by allowing at least one surface in parallel to the printed circuit board to be exposed from the housing, and the bonding layer may be provided to at least one surface other than the exposed surface.

In the electrical connector of a sixth aspect of the present invention, the contact may include an elastically deforming portion that is brought into contact with a mating entity and elastically deformed, an embedded portion to be embedded in the housing, and a connection portion to be connected to a printed circuit board, the embedded portion may include two surfaces that are parallel to the printed circuit board and exposed from the housing, and the bonding layer may be provided to at least one surface other than the exposed surfaces.

In the electrical connector of a seventh aspect of the present invention, the housing may include a holding portion which is protruded in a mating direction of the mating connector and in which the contact is embedded; the contact may include a contact portion extended in the mating direction of the mating connector, and a connection portion to be connected to a printed circuit board; the contact portion may include a contact surface to be brought into contact with the mating connector, and an embedded surface to be embedded in the holding portion; the bonding layer may be provided to the embedded surface; and the contact surface may be exposed from the holding portion.

According to an aspect of the present invention, the electrical connector can be reduced in size with ease because the metallic contact and the resin housing can be bonded together with the bonding layer therebetween to thereby provide enhanced bonding strength.

Furthermore, the metallic contact and the resin housing, which are bonded together with increased adhesion, can prevent the entry of moisture into the boundary between the contact and the housing and thus provide enhanced resistance to corrosion.

### BRIEF DESCRIPTION OF DRAWINGS

FIG. 1 is a perspective view illustrating a mobile terminal on which an electrical connector according to a first embodiment of the present invention is mounted.

FIG. 2 is a perspective view of a portion on the side of the contact surfaces of the electrical connector shown in FIG. 1.

FIG. 3 is a perspective view of a portion on the side of secondary battery connections of the electrical connector shown in FIG. 1.

FIG. 4 is a cross-sectional view of the electrical connector taken along line A-A shown in FIG. 3.

FIG. 5 is a perspective view illustrating a contact of the electrical connector shown in FIG. 1.

FIG. 6 is a cross-sectional view of the contact taken along line B-B shown in FIG. 5.

FIG. 7 is a perspective view illustrating an electrical connector according to a second embodiment of the present invention.

FIG. 8 is a cross-sectional view of a portion near a contact of the electrical connector taken along line C-C shown in FIG. 7.

FIG. 9 is a perspective view illustrating the contact of the electrical connector shown in FIG. 7.

FIG. 10 is a cross-sectional view of the contact taken along line D-D shown in FIG. 9.

FIG. 11 is a perspective view illustrating an electrical connector according to a third embodiment of the present invention.

FIG. 12 is a cross-sectional view of a portion near a contact of the electrical connector taken along line E-E shown in FIG. 11.

FIG. 13 is a perspective view illustrating an electrical connector according to a fourth embodiment of the present invention.

FIG. 14 is a cross-sectional view of a portion near a contact of the electrical connector taken along line F-F shown in FIG. 13.

FIG. 15 is a perspective view illustrating a contact of the electrical connector shown in FIG. 13.

FIG. 16 is a cross-sectional view of the contact taken along line G-G shown in FIG. 14.

FIG. 17 is a perspective view illustrating the structure of a related electrical connector disclosed in Patent Literature 1.

FIG. 18 is a cross-sectional view illustrating the structure of a related electrical connector disclosed in Patent Literature 2.

FIG. 19 is a front view illustrating the structure of a related electrical connector disclosed in Patent Literature 3.

### DESCRIPTION OF EMBODIMENTS

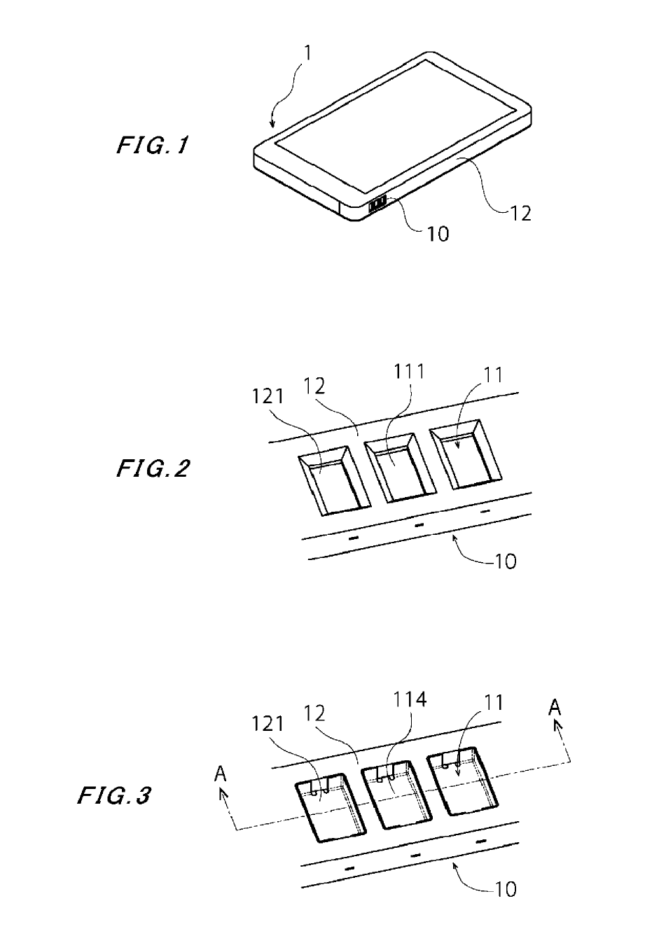

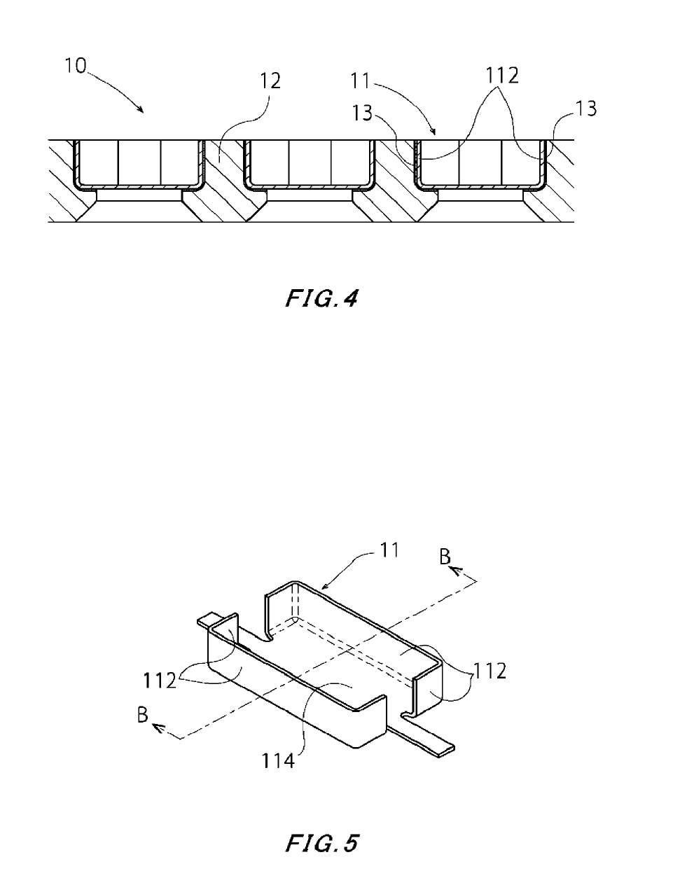

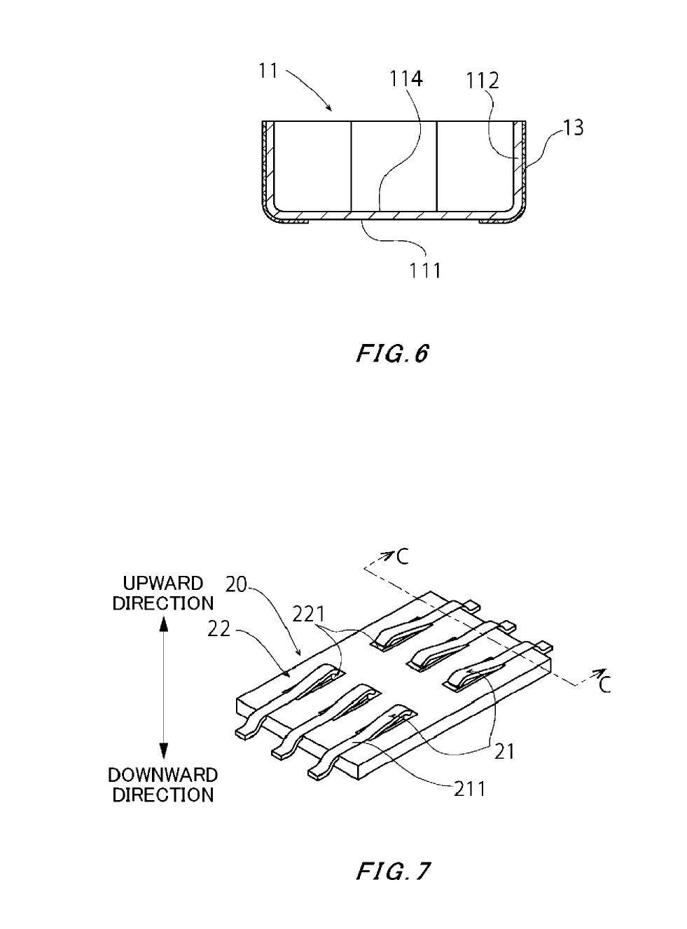

An electrical connector 10 according to a first embodiment of the present invention will be described with reference to FIGS. 1 to 6. Note that for convenience of explanation, FIGS. 4 and 6 illustrate a bonding layer 13 of this embodiment as being thicker than its real one.

Although not illustrated, a mobile terminal 1 accommodates a lithium ion secondary battery therein. The electrical connector 10 is configured to charge the secondary battery. The mobile terminal 1 includes a chassis which is configured from a plurality of parts, and a housing 12 constitutes a surface which is disposed on the side to be mated with a mating connector at the time of charging.

The electrical connector 10 is constituted by a plurality of contacts 11, the housing 12, and a bonding layer 13.

The housing 12 formed from an insulating resin is provided with a rectangular opening 121 which exposes a contact surface 111 on the side closer to the mating connector and a conductor trace surface 114 on the side closer to the secondary battery. The contact 11 is connected to the mating connector through the opening 121, thereby enabling the secondary battery mounted in the mobile terminal 1 to be charged.

The contact 11 formed from a metal plate includes: the contact surface 111 that is rectangular and is in contact with the mating connector to thereby be energized; wall portions 112 provided to extend from each side of the contact surface 111 in such a direction as to intersect the contact surface 111; and the conductor trace surface 114 that is a surface opposite to the contact surface 111.

The conductor trace surface 114 is provided with electric wires for charging the secondary battery.

The adjacent wall portions 112 are consecutively provided. Furthermore, parts of opposing wall portions 112 are notched so as to allow arm portions 113 to be extended so as to be flush with the conductor trace surface 114 between the notches.

On the contact surface 111 of the contact 11 and the wall portions 112 continuing from the contact surface 111, the bonding layer 13 that provides robust bonding when the metal and the resin are integrally molded is formed. This bonding layer 13 is configured such that the bonding layer 13 on the metal surface and the resin are chemically bonded together through the action of pressure and heat. This configuration can achieve robust bonding after the integral molding, thus providing high bonding strength and airtightness. Examples of the bonding layer 13 may include the TRI system (Registered Trademark) available from K.K. TOA Denka.

Another example of the bonding layer 13 will be described below. The contact 11 may also be provided with an air gap formed on the surface by being irradiated with laser light. This allows the housing 12 to enter into the air gap when integrally molding the contacts 11 and the housing 12, thereby enabling the bonding layer 13 to achieve high bonding strength and airtightness. Examples of the bonding layer 13 used in such a case may include the DLAMP (Registered Trademark) available from Daicel Polymer Ltd.

With the contact surface 111 opposed to a mating connector, the plurality of contacts 11 are embedded in the housing 12 with the wall portions 112 of adjacent contacts 11 opposed to each other and with the contacts 11 spaced apart from each other at a certain interval.

As described above, according to this embodiment, the contacts 11 subject to a load imposed by a mating connector can be secured, without the intervention of another part, to the housing 12 constituting the case, reduced in size because no reduced-thickness resin portion exists in the direction of mating, and increased in strength against the load resulting from the mating.

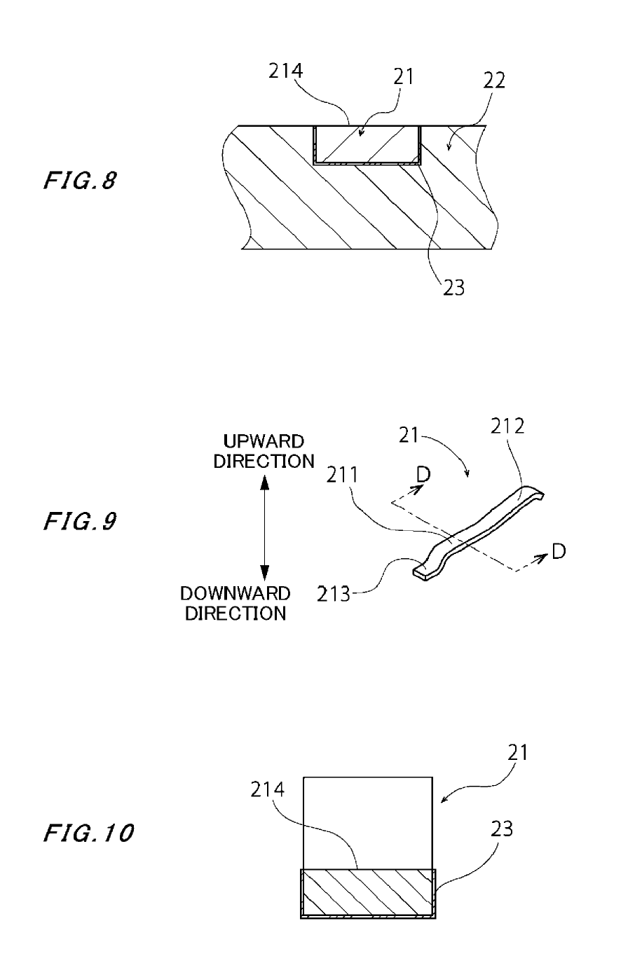

An electrical connector 20 according to a second embodiment of the present invention will be described with reference to FIGS. 7 to 10. Throughout the drawings, the top is defined to be in the upward direction and the bottom to be in the downward direction. Note that for convenience of explanation, FIGS. 8 and 10 illustrate a bonding layer 23 of this embodiment as being thicker than its real one.

The electrical connector 20 is constituted by contacts 21, a housing 22, and the bonding layer 23.

The housing 22 formed from an insulating resin has a rectangular shape when viewed from above and is thicker than the contact 21.

The housing 22 is provided with a clearance 221 so that an elastically deforming portion 212 of the contact 21 does not interfere with the housing when the elastically deforming portion 212 is brought into contact with a mating connector so as to be elastically deformed in the downward direction.

The contact 21 formed from a metal plate includes an embedded portion 211 which is horizontal to the mounting surface of a printed circuit board and extends in one direction so as to be embedded in the housing 22, the elastically deforming portion 212 extending longitudinally along the embedded portion 211 in the upward direction, and a connection portion 213 extended opposite to the elastically deforming portion 212 in the downward direction and mounted on the printed circuit board.

The surface of the embedded portion 211 of the contact 21 has the bonding layer 23 that is formed to achieve robust bonding when the metal and the resin are integrally molded. This bonding layer 23 is configured such that the bonding layer 23 on the metal surface and the resin are chemically bonded together through the action of pressure and heat. This configuration can achieve robust bonding after the integral molding, thus providing high bonding strength and airtightness. Examples of the bonding layer 23 may include the TRI system (Registered Trademark) available from K.K. TOA Denka.

Another example of the bonding layer 23 will be described below. The contact 21 may also be provided with an air gap formed on the surface by being irradiated with laser light. This allows the housing 22 to enter into the air gap when integrally molding the contacts 21 and the housing 22, thereby enabling the bonding layer 23 to achieve high bonding strength and airtightness. Examples of the bonding layer 23 used in such a case may include the DLAMP (Registered Trademark) available from Daicel Polymer Ltd.

The contact 21 is disposed such that an exposed surface 214, which is a surface in the upward direction of the embedded portion 211, is flush with the upper surface of the housing 22. Furthermore, the contacts 21 are arranged such that three rows of embedded portions 211 are disposed in parallel with one another while being spaced apart from and opposed to one another.

Each of the contacts 21 disposed as described above is embedded in the housing 22 with the exposed surface 214 not covered.

As described above, according to this embodiment, the embedded portion 211 can be secured to the housing 22 by the bonding layer 23 with a sufficient strength without covering the entire perimeter with the resin, thereby reducing the height of the electrical connector 20.

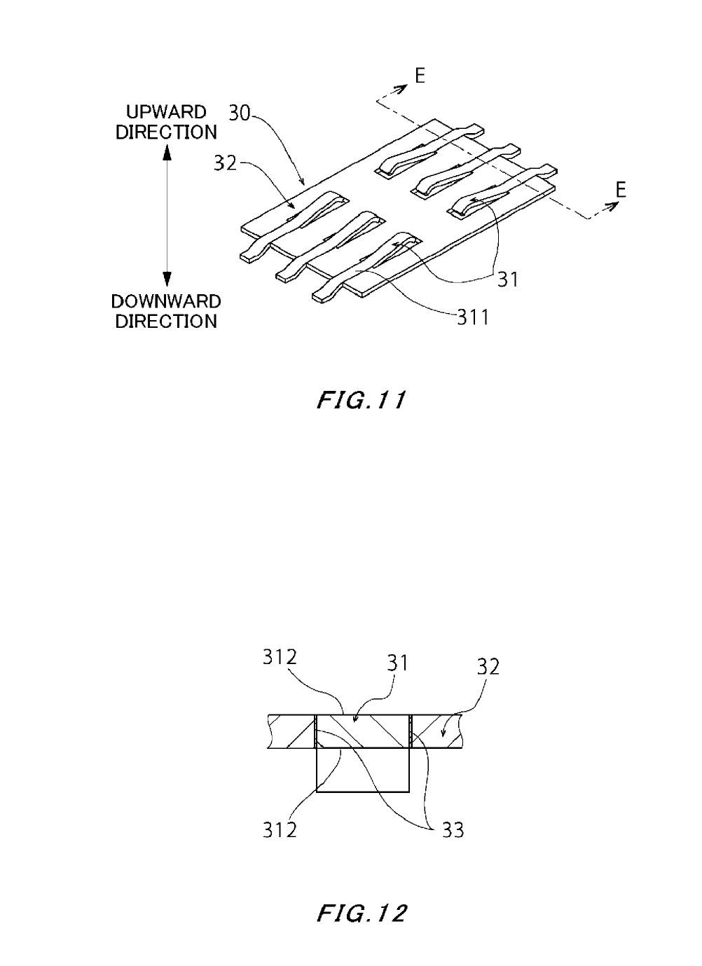

An electrical connector 30 according to a third embodiment of the present invention will be described with reference to FIGS. 11 to 12. Throughout the drawings, the top is defined to be in the upward direction and the bottom to be in the downward direction. Note that for convenience of explanation, FIG. 12 illustrates a bonding layer 33 of this embodiment as being thicker than its real one.

Since the structure of this embodiment is almost the same as that of the second embodiment, a description will be given only to different points of the structure.

A housing 32 formed from an insulating resin has a rectangular shape when viewed from above and the same thickness as that of a contact 31.

The surface of an embedded portion 311 of the contact 31 has the bonding layer 33 that is formed to achieve robust bonding when the metal and the resin are integrally molded. This bonding layer 33 is configured such that the bonding layer 33 on the metal surface and the resin are chemically bonded together through the action of pressure and heat. This configuration can achieve robust bonding after the integral molding, thus providing high bonding strength and airtightness. Examples of the bonding layer 33 may include the TRI system (Registered Trademark) available from K.K. TOA Denka.

Another example of the bonding layer 33 will be described below. The contact 31 may also be provided with an air gap formed on the surface by being irradiated with laser light. This allows the housing 32 to enter into the air gap when integrally molding the contacts 31 and the housing 32, thereby enabling the bonding layer 33 to achieve high bonding strength and airtightness. Examples of the bonding layer 33 used in such a case may include the DLAMP (Registered Trademark) available from Daicel Polymer Ltd.

As described above, according to this embodiment, it is possible to further reduce the height of the electrical connector 30 as compared with the second embodiment because exposed surfaces 312 or the surfaces of the embedded portion 311 in the upward and downward directions can be secured by the bonding layer 33 to the housing 32 with a sufficient strength without being covered with the resin.

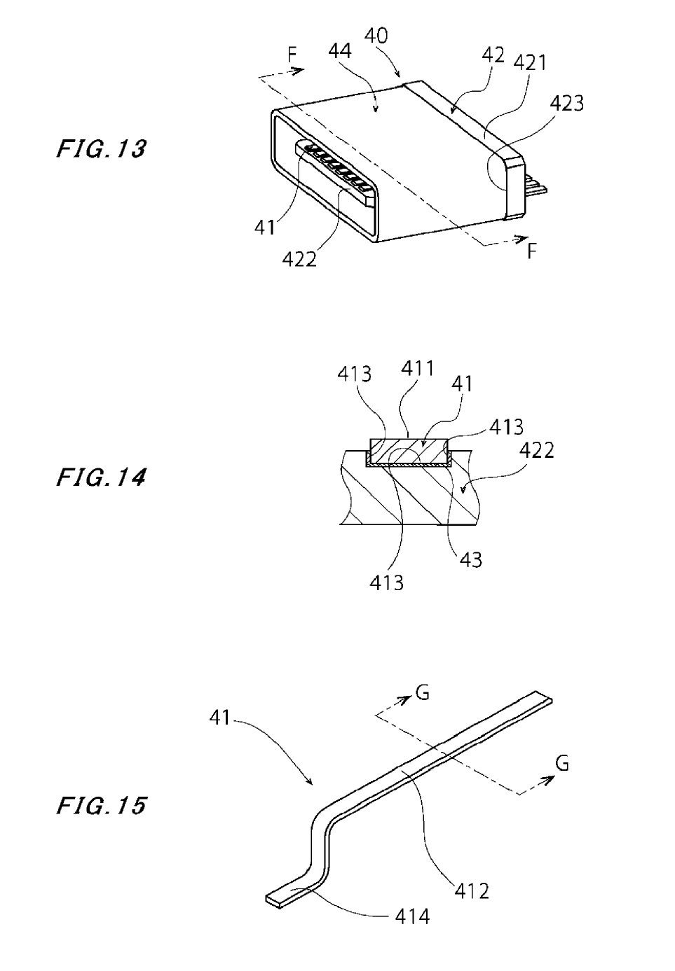

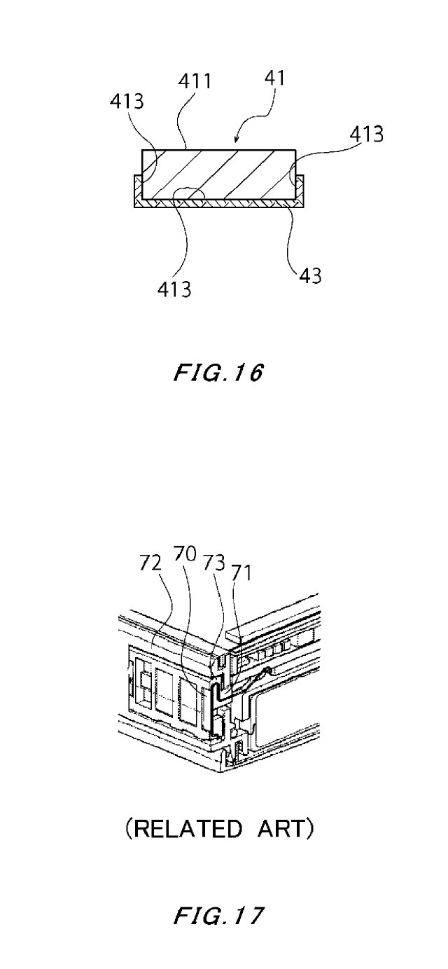

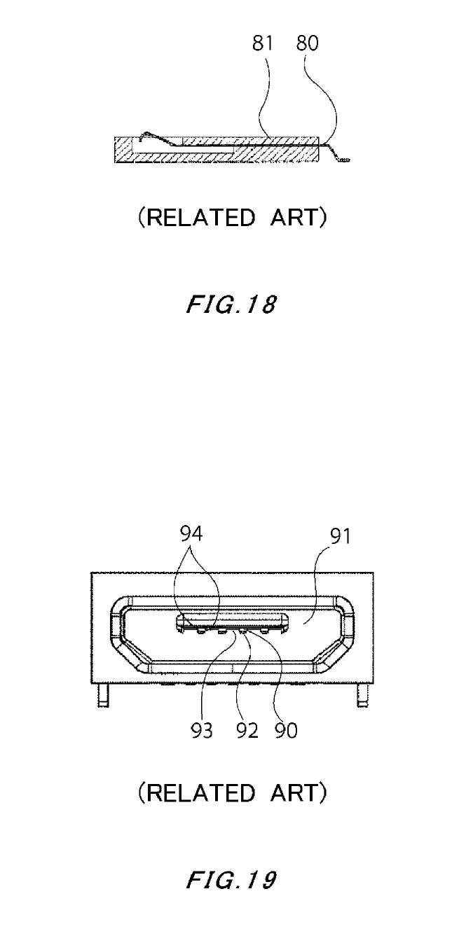

An electrical connector 40 according to a fourth embodiment of the present invention will be described with reference to FIGS. 13 to 16. Note that for convenience of explanation, FIGS. 14 and 16 illustrate a bonding layer 43 of this embodiment as being thicker than its real one.

The electrical connector 40 is constituted by contacts 41, a housing 42, the bonding layer 43, and a case 44.

The housing 42 formed from an insulating resin includes a rectangular parallelepiped main body 421, and a plate-shaped holding portion 422 that is extended from the main body 421 in the mating direction of a mating connector.

Around the holding portion 422 of the housing 42, the case 44 that is spaced apart from the holding portion 422 is disposed.

The case 44, which is formed from a metal plate, is shaped to have a through hole in the mating direction of a mating connector and disposed with one open side abutted against a receiving surface 423 of the housing 42.

The contact 41 formed from a metal plate includes a contact portion 412 which is horizontal to the mounting surface of a printed circuit board and which extends in the mating direction of a mating connector, and a connection portion 414 extended opposite to the contact portion 412 and mounted on the printed circuit board.

The surface of the contact portion 412 in the upward direction includes a contact surface 411 configured to be in contact with a contact of a mating connector.

In the range in which the contact portion 412 of the contact 41 is embedded in the holding portion 422, the bonding layer 43 is formed which can achieve robust bonding when the metal and the resin are integrally molded. This bonding layer 43 is configured such that the bonding layer 43 on the metal surface and the resin are chemically bonded together through the action of pressure and heat. This configuration can achieve robust bonding after the integral molding, thus providing high bonding strength and airtightness. Examples of the bonding layer 43 may include the TRI system (Registered Trademark) available from K.K. TOA Denka.

Another example of the bonding layer 43 will be described below. The contact 41 may also be provided with an air gap formed on the surface by being irradiated with laser light. This allows the housing 42 to enter into the air gap when integrally molding the contacts 41 and the housing 42, thereby enabling the bonding layer 43 to achieve high bonding strength and airtightness. Examples of the bonding layer 43 used in such a case may include the DLAMP (Registered Trademark) available from Daicel Polymer Ltd.

A plurality of contacts 41 having the bonding layer 43 and the housing 42 are integrally molded. At that time, the plurality of contacts 41 are arranged so that the contact surfaces 411 are disposed on the same plane and the contact portions 412 are parallel to each other and spaced apart from each other at equal intervals. Furthermore, the contact surface 411 of the contact 41 is embedded while being protruded from the surface of the holding portion 422 of the housing 42.

As described above, according to this embodiment, an embedded surface 413 can be brought into intimate contact with the housing 42 with the bonding layer 43 therebetween. This arrangement prevents moisture from entering into the boundary between the contacts 41 and the housing 42, thereby enhancing resistance to corrosion at the time of energization.

For example, an embodiment of the present invention can be preferably employed for electrical connectors to be used with mobile terminals.

### REFERENCE SIGNS LIST

1 mobile terminal
10 electrical connector
11 contact
111 contact surface
112 wall portion
113 arm portion
114 conductor trace surface
12 housing
121 opening
13 bonding layer
20 electrical connector
21 contact
211 embedded portion
212 elastically deforming portion
213 connection portion
214 exposed surface
22 housing
221 clearance
23 bonding layer
30 electrical connector
31 contact
311 embedded portion
312 exposed surface
32 housing
33 bonding layer
40 electrical connector
41 contact
411 contact surface
412 contact portion
413 embedded surface
414 connection portion
42 housing
421 main body
422 holding portion
423 receiving surface
43 bonding layer
44 case
70 contact
71 holder
72 chassis
73 projection
80 contact
81 housing
90 contact
91 housing
92 contact surface
93 hold surface
94 side surface

1. An electrical connector comprising:
a metallic contact; and
a housing molded integrally with the contact and made of an insulating resin, wherein
the contact has, on at least part thereof in contact with the housing, a bonding layer bonded to the housing, and
the contact and the housing are bonded together with the bonding layer therebetween.

2. The electrical connector according to claim 1, wherein the bonding layer is a layer configured to chemically bond the contact and the housing together.

3. The electrical connector according to claim 1, wherein
the contact includes an air gap on a surface thereof, and
the bonding layer is a layer formed by insulating resin of the housing entering into the air gap so as to bond the contact and the housing together.

4. The electrical connector according to claim 1, wherein
the contact includes a contact surface to be brought into contact with a mating connector, and a wall portion provided to extend in a direction in which the wall portion intersects the contact surface, and
the bonding layer is provided to at least part of a surface of the wall portion.

5. The electrical connector according to claim 1, wherein
the contact includes an elastically deforming portion that is brought into contact with a mating entity and elastically deformed, an embedded portion to be embedded in the housing, and a connection portion to be connected to a printed circuit board,
the embedded portion includes an exposed surface that is formed by allowing at least one surface in parallel to the printed circuit board to be exposed from the housing, and
the bonding layer is provided to at least one surface other than the exposed surface.

6. The electrical connector according to claim 1, wherein
the contact includes an elastically deforming portion that is brought into contact with a mating entity and elastically deformed, an embedded portion to be embedded in the housing, and a connection portion to be connected to a printed circuit board,
the embedded portion includes two surfaces that are parallel to the printed circuit board and exposed from the housing, and
the bonding layer is provided to at least one surface other than the exposed surfaces.

7. The electrical connector according to claim 1, wherein
the housing includes a holding portion which is protruded in a mating direction of the mating connector and in which the contact is embedded;
the contact includes a contact portion extended in the mating direction of the mating connector, and a connection portion to be connected to a printed circuit board;
the contact portion includes a contact surface to be brought into contact with the mating connector, and an embedded surface to be embedded in the holding portion;
the bonding layer is provided to the embedded surface; and
the contact surface is exposed from the holding portion.
